(19) United States
(12) Patent Application Publication
(10) Pub. No.: US 2008/0297657 A1
(43) Pub. Date: Dec. 4, 2008

(54) METHOD AND SYSTEM FOR PROCESSING TEXT IN A VIDEO STREAM

(76) Inventors: Richard Griffiths, Cambridge (GB); Robert Swann, Cambridge (GB); Neil Johnson, Cambridge (GB); Kevin Bracey, Cambridge (GB)

Correspondence Address: MCANDREWS HELD & MALLOY, LTD, 500 WEST MADISON STREET, SUITE 3400, CHICAGO, IL, 60661, US

(21) Appl. No.: 11/757,666

(22) Filed: Jun. 4, 2007

(51) Int. Cl. H04N 5/445

(52) U.S. Cl. 348/564

(57) ABSTRACT

The disclosed systems and methods achieve improved communication of the text in a video stream. Text may be processed separately from the video stream to suit the capabilities of a display device or to improve the availability of the textual information to users with special requirements. The disclosed methods and systems may be used, for example, in conjunction with set-top-box decoders, mobile telephones, and portable media players with small or low-resolution display screens.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Video displays on multimedia devices come in many sizes. When a video image is scaled to fit the display size, textual information that may be contained in the video image is also scaled. Compact video displays may result in the scaling of text to the extent that the text is unreadable.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for processing text in a video stream, substantially as shown in and/or described in connection with at least one of the figures, as set forth more completely in the claims. Advantages, aspects and novel features of the present invention, as well as details of an illustrated embodiment thereof, will be more fully understood from the following description and drawings.

### BRIEF DESCRIPTION OF THE DRAWINGS

FIG. 1 is a flowchart illustrating an exemplary method for processing text in a video stream in accordance with a representative embodiment of the present invention;

FIG. 2 is an illustration of a first exemplary system for processing text in a video stream in accordance with an embodiment of the present invention;

FIG. 3 is an illustration of a second exemplary system for processing text in a video stream in accordance with an embodiment of the present invention; and

FIG. 4 is an illustration of a third exemplary system for processing text in a video stream in accordance with an embodiment of the present invention.

### DETAILED DESCRIPTION OF THE INVENTION

Aspects of the present invention relate to technique for modifying the way in which text is presented in video material, either to suit the capabilities of a display device or to improve its availability to users with special requirements. The following methods and systems may be used, for example, in conjunction with set-top-box decoders and multimedia processors. Although the following description may refer to particular wireless communication standards, many other standards may also use these systems and methods.

The following methods and systems may be particularly applicable to small or low-resolution display screens. This type of display is generally used in mobile telephones and in portable media players. If the video content was originally intended for display on a conventional television, the text may be difficult to read on a small screen. The following methods and systems can make the text easier to read. Moreover, the following methods and systems can be used by partially-sighted users to improve the clarity of text displayed on a conventional television or video screen.

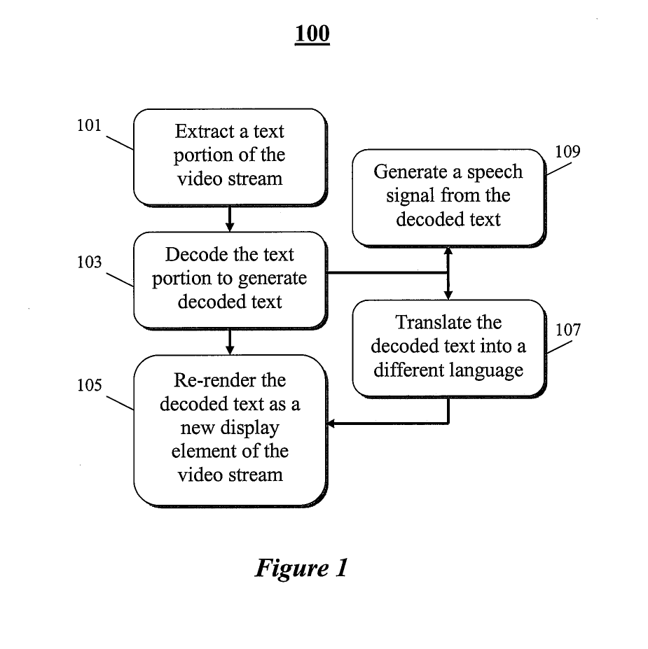

FIG. 1, 100, is a flowchart illustrating an exemplary method for processing text in a video stream. The method begins by extracting the text content of a video data stream, 101. The video data stream may be received from a television transmission, from a media file, or from any other source.

The text content is then decoded, 103. The text to be extracted may be included in the main video image, or it may be included in supplementary data (“metadata”) that is part of or associated with the television transmission or the media file. If the text is in an image format, the text would be decoded using optical character recognition techniques. For example, text may be in an image format included in a video image, encoded as a bitmap, or stored in another video format in the metadata.

The extracted and decoded text may be modified in various ways prior to being presented to the user. The extracted text may be re-rendered and displayed, 105. The re-rendered text may typically replace the original text. The re-rendered text may be displayed in a clearer font or in a larger font. The processed text may be, for example, news and stock tickers, captions, subtitles for the hearing impaired and subtitles that translate foreign-language speech.

The decoded text may be translated into a different language, 107. For example, subtitles intended for the hearing impaired could be translated for use by users that do not understand the language of the soundtrack, and subtitles on foreign-language content could be translated into a third language.

The decoded text may also be used in conjunction with an automatic speech generation system to speak the text that is displayed on the screen, 109. This may be useful for blind and partially-sighted users and for users that have difficulty reading. Audio processing may be used to make the generated speech and the original soundtrack appear to originate from different locations. Audio processing may also be combined with language translation to generate speech in a language other than the language of the decoded text.

Enabling or disabling the foregoing functionality may be automatic or used-controlled.

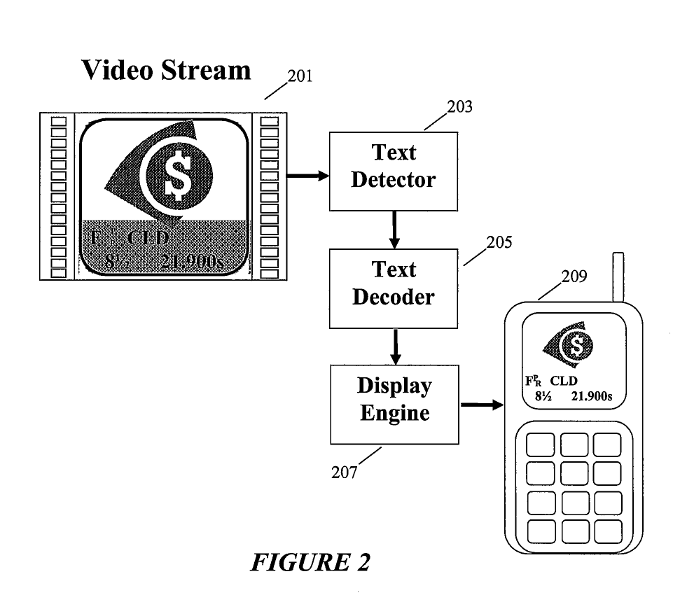

FIG. 2 is an illustration of a first exemplary system for processing text in a video stream. The video stream, 201, may be received from a television transmission, from a media file, or from any other source.

The text content of the video stream is extracted by a text detector, 203. The text to be extracted may be included in the main video image, or it may be included in supplementary data (“metadata”) that is part of or associated with the television transmission or the media file.

The extracted text is decoded by the text decoder, 205. If the text is in an image format, the text would be decoded using optical character recognition techniques. For example, text may be in an image format included in a video image, encoded as a bitmap, or stored in another video format.

The decoded text may be modified in various ways prior to being presented to the user. The extracted text may be re-rendered by a display engine, 207. The display engine, 207, may insert the re-rendered text in place of the extracted text. The re-rendered text may be displayed in a clearer font or in a larger font. For example, a mobile media device, 209, may have a small screen. The display engine, 207, may automatically display the text with a legible font. Alternatively, the re-rendered text size may be adjustable by the user of the mobile media device, 209.

The processed text may be, for example, news and stock tickers, captions, subtitles for the hearing impaired, and subtitles that translate foreign-language speech.

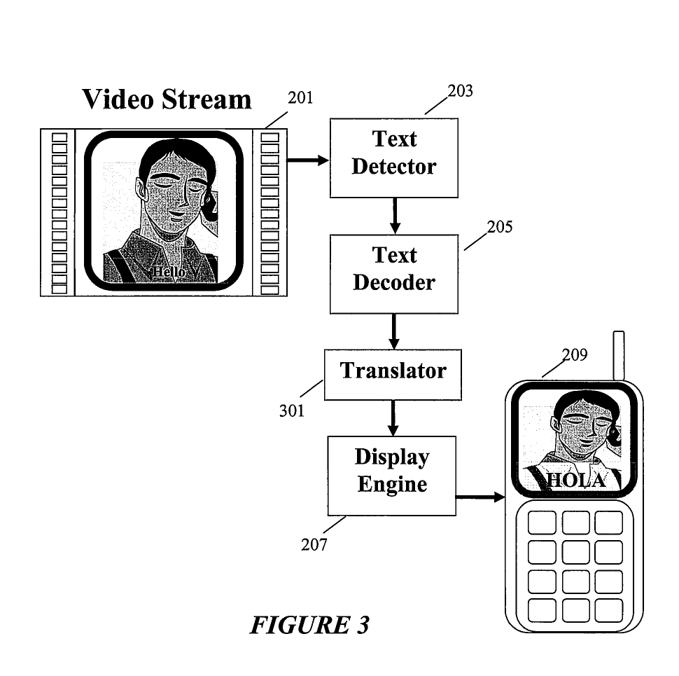

The decoded text may also be translated into a different language. FIG. 3 is an illustration of a second exemplary system for processing text in a video stream. In FIG. 3 decoded text in English may be translated, for example, into Spanish with a translator, 301, between the text decoder, 205, and the display engine, 207.

Additionally, subtitles intended for the hearing impaired could be translated for use by users that do not understand the language of the soundtrack, and subtitles on foreign-language content could be translated into a third language.

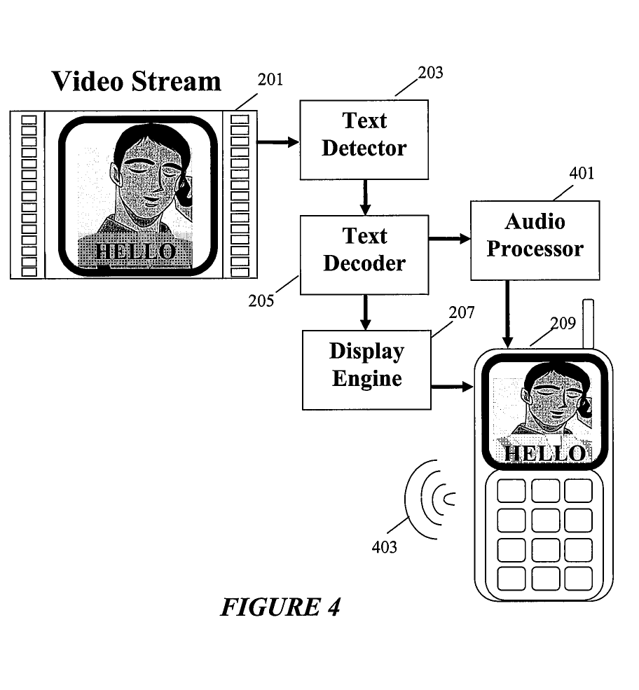

The decoded text may also be used in conjunction with an automatic speech generation system to speak the text that is displayed on the screen. FIG. 4 is an illustration of a third exemplary system for processing text in a video stream. For blind and partially-sighted users and for users that have difficulty reading, an audio processor, 401, may be used to generate speech, 403, from the decoded text. The original soundtrack may also be made to originate from a mobile media device, 209, or from a different location, e.g. a Bluetooth headset.

Audio processing may also be combined with language translation to generate speech in a language other than the language of the decoded text.

The present invention may be realized in hardware, software, or a combination of hardware and software. The present invention may be realized in a centralized fashion in an integrated circuit or in a distributed fashion where different elements are spread across several circuits. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing a video stream, wherein the method comprises:
extracting a text portion of the video stream;
decoding the text portion, thereby generating a decoded text; and
re-rendering the decoded text as a new display element of the video stream.

2. The method of claim 1, wherein the text portion is a stock ticker.

3. The method of claim 1, wherein the decoded text is a subtitle.

4. The method of claim 1, wherein the method further comprises the step of translating the decoded text into a different language.

5. The method of claim 4, wherein the method further comprises the step of generating a speech signal from the translated text.

6. The method of claim 1, wherein the method further comprises the step of generating a speech signal from the decoded text.

7. The method of claim 1, wherein the new display element replaces the text portion.

8. The method of claim 1, wherein a font size of the new display element is larger than a font size of the text portion.

9. The method of claim 1, wherein decoding the text portion utilizes optical character recognition techniques.

10. The method of claim 1, wherein the text portion is an image portion of the video data stream.

11. The method of claim 1, wherein the text portion is supplementary data associated with the video data stream.

12. The method of claim 1, wherein the video data stream is a television transmission.

13. The method of claim 1, wherein the video data stream is a media file.

14. The method of claim 1, wherein a font in the new display element is clearer than a font in the text portion.

15. A system for processing a video stream, wherein the system comprises:
a detector for extracting a text portion of the video stream;
a decoder for generating a decoded text from the text portion; and
a display engine for re-rendering the decoded text as a new display element of the video stream.

16. The system of claim 15, wherein the text portion is a stock ticker.

17. The system of claim 15, wherein the decoded text is a subtitle.

18. The system of claim 15, wherein the system further comprises a translator for translating the decoded text into a different language.

19. The system of claim 18, wherein the system further comprises an audio processor for generating a speech signal from the translated text.

20. The system of claim 15, wherein the system further comprises an audio processor for generating a speech signal from the decoded text.

21. The system of claim 15, wherein the new display element replaces the text portion.

22. The system of claim 15, wherein a font size of the new display element is larger than a font size of the text portion.

23. The system of claim 15, wherein the decoder includes optical character recognition.

24. The system of claim 15, wherein the text portion is an image portion of the video data stream.

25. The system of claim 15, wherein the text portion is supplementary data associated with the video data stream.

26. The system of claim 15, wherein the video data stream is a television transmission.

27. The system of claim 15, wherein the video data stream is a media file.

28. The system of claim 15, wherein a font in the new display element is clearer than a font in the text portion.
